(19) United States
(12) Patent Application Publication
(10) Pub. No.: US 2012/0181091 A1
(43) Pub. Date: Jul. 19, 2012

(54) System and method for weighing an item on a mobile device

(76) Inventor: Nhi H. Lieu, Toronto (CA)

(21) Appl. No.: 12/929,320

(22) Filed: Jan. 14, 2011

(51) Int. Cl. G01G 19/413

(52) U.S. Cl. 177/1; 177/25.13; 177/25.15

(57) ABSTRACT

A mobile portable system for a user to weigh an item on a mobile device, the mobile device having a computer processor and a display screen, and a weighing platform integral to the mobile device. The weighing platform may be integral to the display screen or may be a separate piece of hardware. A selector module is provided for allowing the user of the mobile device to choose the type of the item to be weighed. A weighing module is also provided for determining the weight of the item placed by the user on the weighing platform. A visual module in communication with the weighing module is provided to display the weight of the item to the user. The selector module, the weighing module, and the display module are executed by the computer processor of the mobile device. In another embodiment, the invention includes a communications manager to send the weight and the type of the item to a marketplace over a network, the marketplace being adapted to send the real-time price back to the mobile device for further display to the user.

### FIELD OF THE INVENTION

The invention relates to the field of mobile device applications, and more particularly, to a mobile device having a system for weighing an item placed on a weighing platform which is integrally connected to a mobile device, wherein the weighing platform may be integral with the display screen of the mobile device, and to a method of operating the system.

### BACKGROUND OF THE INVENTION

Various types of electronic weighing devices are known. Electronic scales, for example, are often digital or analogue scales that are stand-alone devices (i.e. the electronic scales are not connected to another apparatus such as a computer). These electronic scales have a weighing platform and a digital display. When a user of the electronic scale places an item on the weighing platform, the digital display shows the weight of the item, usually in real-time. This type of electronic scale suffers from several disadvantages. First, the electronic scale has limited functionality because it is not connected to a computer. The user can only weigh an item and cannot communicate the weight to an electronic marketplace to get the real-time value of the item or sell the item online. Second, electronic scales are often heavy and bulky, and thus are not suitable for mobility by carrying around on one's person or in a small bag.

Another type of electronic scale known in the art is an external digital scale that is connectable to a computer. Such scales are able to communicate with a software application running on the computer. Typically, the external scale is connected to the computer using a Universal Serial Bus (USB) cable or another communications port. Unfortunately, this type of external scale also has several deficiencies. First, it is often necessary for the user to install and configure specialized software and/or drivers so that the external scale can communicate correctly with the computer. Many people do not have this specialized technical knowledge, and even if a user is able to correctly connect the external scale with the computer, this may take significant time and effort. The user often then has to start an application on the computer which may be difficult to find on the operating system and use if the user is able to start the application at all. Second, most mobile devices such as a cell phone or a personal digital assistant (PDA) do not have the capability to connect to an external scale. Many mobile devices simply do not have the interface connections (such as USB ports) to connect to external scales. Even if a mobile device can connect and communicate with the external scale, the external scale is still bulky. It is therefore inconvenient to carry both the mobile device and the external scale just in case the user wants to weigh something while on the move.

Therefore, there exists a need for a mobile weighing application adapted to allow users to weigh an item on a mobile device to overcome at least some of the deficiencies known in the prior art.

### SUMMARY OF THE INVENTION

In its broad aspect, there is provided mobile device having a system for weighing an item on the mobile device where the mobile device includes at least one computer processor and a display screen. At least one weighing platform is integral to the mobile device and is adapted to receive the item. A selector module is provided for allowing a user of the mobile device to choose the identity of the item to be weighed. A weighing module is also provided for determining the weight of the item placed by the user on the weighing platform. A display module in communication with the weighing module is provided to display the weight of the item to the user of the mobile device. The selector module, the weighing module, and the display module are executed by the at least one computer processor of the mobile device.

In another aspect, there is provided a communications module for communicating the weight of the item to an external marketplace in which the communications module is executed by the at least one computer processor.

In yet another aspect, there is provided a value module for determining the real-time market value of the item weighed in which the value module is executed by the at least one computer processor.

In another of its aspects, the weighing platform and the display screen are integral with one another.

In a broad aspect, the invention also provides a method for determining the weight of an item using a mobile device, the mobile device having at least one computer processor, a weighing platform and a display screen. The method includes the steps of selecting the identity of the item to be weighed, placing the item on the weighing platform, and determining the weight of the item by the at least one computer processor executing a weighing module, and displaying the weight of the item on the display screen.

In another aspect, the user is prompted to place the item on the weighing platform.

In yet another aspect, the method includes the step of communicating the weight to an external marketplace.

In another of its aspects, the method includes the step of retrieving the real-time price of the item from an external marketplace.

In another aspect, the method includes the step of allowing the user to sell the item on an external marketplace at a pre-determined price.

In a broad aspect, the invention also provides a system for communicating the weight of an item to a marketplace. The system includes a mobile device having at least one computer processor, a display screen, a weighing platform, a receiver and a transmitter. The mobile device is configured to weigh the item on the weighing platform. The transmitter is adapted to send the weight to a communications relay. The communications relay is configured to relay the weight to at least one network. The at least one network is further adapted to send the weight of the item to the marketplace.

In yet another aspect, the system includes a transaction processor coupled to the marketplace for allowing a user to sell the item on the marketplace to another party.

### BRIEF DESCRIPTION OF THE DRAWINGS

The present invention can be better understood with reference to the attached drawings, in which:

FIG. 1 shows an embodiment of a system of the present invention;

FIG. 2a shows a design of a mobile device which is appropriate to use with an embodiment of the present invention;

FIG. 2b shows another design of a mobile device which is appropriate to use with an embodiment of the present invention;

FIG. 3 shows a component diagram of modules that are used in an embodiment of the present invention;

FIG. 4 shows a flow-chart illustrating the steps of the method used by an embodiment of the present invention; and,

FIG. 5 shows a flow-chart illustrating the steps of the method conducted by another embodiment of the present invention.

### DETAILED DESCRIPTION

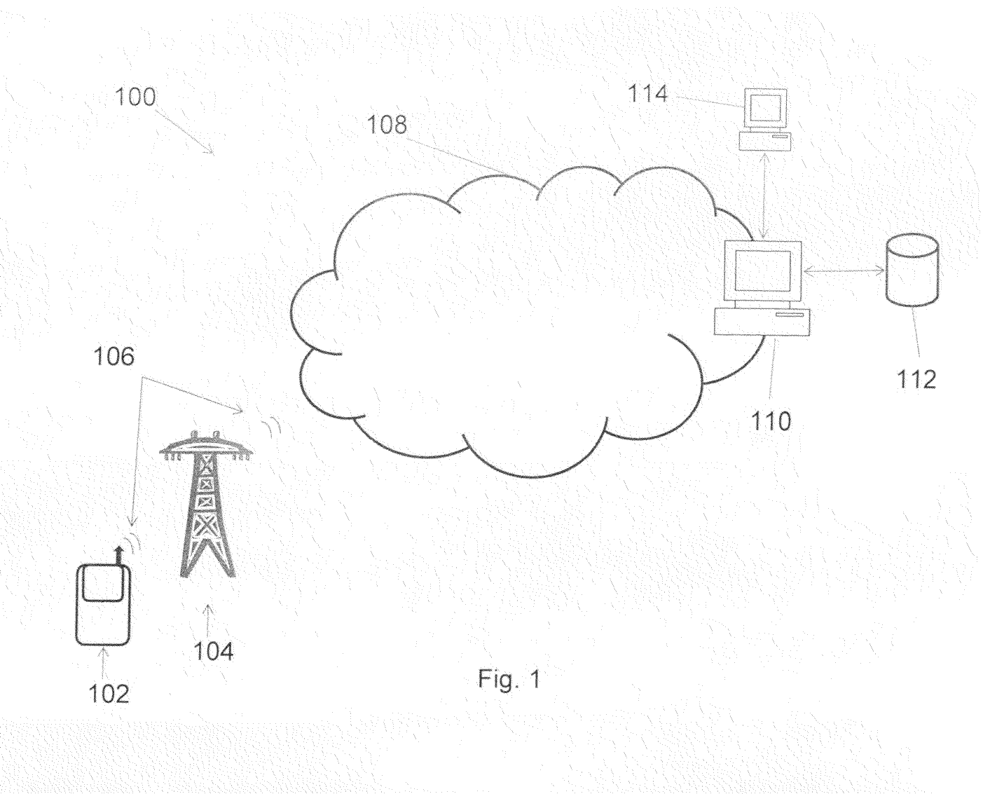

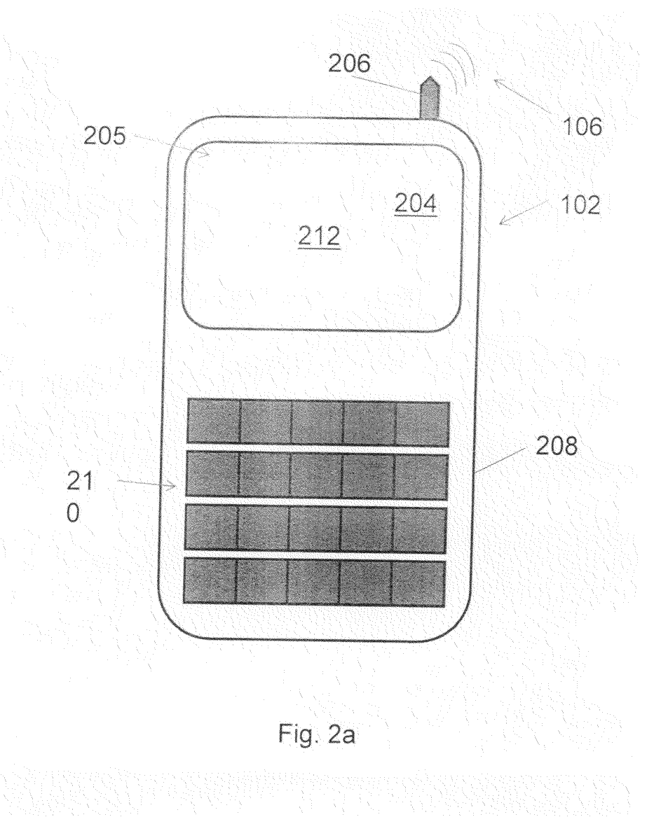

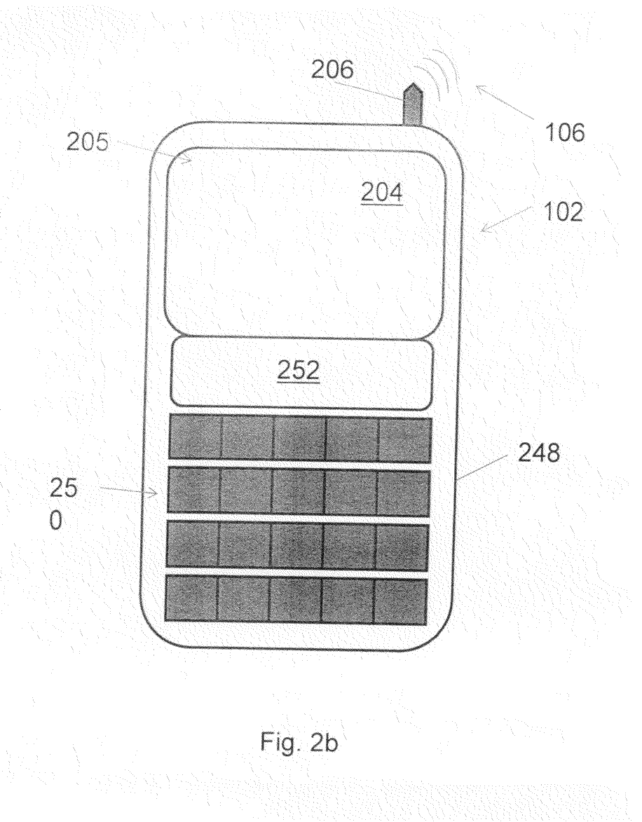

Reference is first made to FIGS. 1, 2a and 2b to describe an embodiment of a system for the purposes of illustrating the invention.

The system is indicated generally by numeral 100. The system 100 is for weighing an item (not shown) on the weighing platform 212, 252 of the mobile device 102 and for communicating the weight of the item to a marketplace 110. A mobile device 102, as explained below is adapted to provide a function as a digital scale to weigh the item (not shown) using a mobile application running on the mobile device 102. The mobile application is executed by the mobile device processor as will be appreciated by one skilled in the art on the commands of the user and other events 320. The mobile application interfaces with the display screen 204 to output the weight and other commands visually to the user. The weighing scale 212, 252 may be integral with the display screen 204 such that the user is able to weigh the item by placing the item on the display screen 204. The user may desire to determine the real-time market price of the item by communicating with an external marketplace 110. An antenna 206 functions as both a transmitter and a receiver of wireless signals and sends the signals 106 representing the weight of the item to a communications relay 104, such as a wireless communications tower. The communications relay 104 processes the signal and relays it to an appropriate network 108 where the signal 106 is processed by an external marketplace 110. It will be appreciated by one skilled in the art, that in practice, the communications relay 104 and the network 108 may be any combination of wireless and wired networks, including transmitting media, communication relays, routers, switches, and other hardware, software and/or firmware that exist to propagate a signal from a mobile device 102 to another computer processor via a communications network.

For the sake of this application, it will be appreciated that the mobile device 102 is a computer that is capable of wireless communication. The mobile device 102 necessarily includes a computer processor, at least one hard drive, random access memory (RAM), at least one antenna that provides both transmitter and receiver functionality, an operating system coupled to the computer processor and a display screen. Examples of mobile devices known in the art are personal digital assistants (PDAs), cellular phones and laptop computers. Referring to FIGS. 2a and 2b, the mobile device 102 has a user interface 205 for interacting with the mobile application, the user interface 205 being connected to a memory (not shown) via a communications link such as a BUS (not shown). The user interface 205 is coupled to a processor via a BUS, to interact with the user events 320 (as well as programmed events) to monitor or otherwise instruct the operation of the mobile application via an operating system. The user interface 205 can include one or more user input devices such as but not limited to a QWERTY keyboard, a keypad, a track wheel, a stylus, a touch sensitive display, a mouse, a microphone and other known input/output devices. The display screen 204 is an example of a user output device, such as but not limited to a computer screen display. If the screen is touch sensitive, then the display 204 can also be used as the user input device as controlled by the processor. Further, it is recognized that the mobile device 102 may include at least one computer readable storage medium coupled to the processor for providing operating instructions to the processor and/or the mobile application. The computer readable medium may include hardware and/or software such as, by way of example only, magnetic disks, magnetic tape, optically readable medium such as CD/DVD ROMS, and memory cards in each case, the computer readable medium may take the form of a small disk, floppy diskette, cassette, hard disk drive, solid-state memory card, or RAM provided in memory. It should be noted that the above listed example computer readable mediums can be used either alone or in combination. The mobile application itself may include software, hardware and/or firmware alone or in combination and may reside in RAM, on a hard-drive, on an external storage medium or may be distributed wirelessly to the user of the mobile device 102.

The system 100 of the present application is adapted to work with current and future digital scale (i.e. weighing) technologies that are or may become available. An example is provided in patent application no. For the purposes of this application, a digital scale is any device that is adapted to provide a digital signal to a computer processor representing the weight of an item weighed on the scale. It will be appreciated that digital scales may encompass a variety of technologies such as but not limited to analytical balance, digital load cells, and hydraulic and pneumatic technology.

The item may be any object, set of objects, commodity, etc. that the user wants to weigh on the mobile device 102. For example, it will be appreciated that a user may want to use the mobile device 102 to weigh valuable commodities such as gold, silver and platinum and items such as precious jewelry. As will be described, the user can then use the mobile device 102 to determine the real-time or spot market price of the item weighed to determine the actual value of the item. It will be appreciated by a person skilled in the art that any item may be weighed on the mobile device 102 including bulk foods, metals, building materials, etc., the only limitation being the size of the weighing platform 212, 252 and the minimum and maximum physical thresholds of the mobile application and the weighing platform.

Continuing to refer to FIGS. 1, 2a and 2b, the mobile device 102 is in communication with a network 108 via a communications relay 104 such as a wireless tower. A user of the system 100 may desire to weigh an item (not shown) on the mobile device 102 and communicate the weight to another party such as marketplace 110. The marketplace 110 may further be in communication with a buyer which is accessing the marketplace 110 via computer 114 which is in communication with the marketplace 110. An example of using the system is given as follows. The user launches an application (not shown) on the mobile device 102 by interfacing with the mobile device's operating system. It will be appreciated that the user may access the application via a touch screen, a mouse, a wheel, a stylus, a combination of these, or by using many other methods. Once the application is started, the user places the item on the weighing platform 212, 252 and the application computes the weight by interfacing a weighing mechanism in communication with the weighing platform 212, 252. It will be appreciated that the weighing platform 212 may be integral with the display screen 204 such that the user is able to place the item directly on the display screen 204 to determine the weight. In another embodiment, the weighing platform 252 is a distinct piece of hardware from the display screen 204 as is shown in FIG. 2b.

In one embodiment, the user may choose to communicate the weight to a third party such as marketplace 110 or the user of computer 114. It will be appreciated that the system 100 provides the capability of allowing the user of the mobile device 102 to sell the item directly to the user of computer 114 or to place the item on sale using a marketplace such as eBay, Craigslist and many other electronic sites including a vast number of social media websites. It will be understood that because the mobile device 102 is a computer capable of wireless communication, the user of the mobile device 102 can sell the item using any technology that is found on common personal computers having wired and/or wireless internet access capability. For example, the application may provide a set of links to internet sites where the user already has accounts or would like to set up an account. The user can access these links by clicking on them and will be directed to the links using a wireless-enabled mobile browser. Once the user is directed to a specific site, the user can navigate the site, send email and/or messages to potential buyers, place the item up for sale, bid on other items, just as though the user was gaining access to the internet sites using a personal computer with wired Internet access. In another embodiment, the user can use both his/her mobile device 102 and another personal computer to access the desired internet sites and increase the probability of selling the item.

It will be appreciated that mobile devices 102 often provide additional functionality such as creating digital pictures and videos, accessing email, and sending SMS (short message service) and MMS (multimedia messaging service) messages to friends and contacts. In one embodiment, the mobile device application is adapted to interact with digital files such as pictures and video and to upload these files to the external marketplace 110. For example, the user may desire to photograph the item, and then upload the photograph together with the weight and/or market price of the item to a marketplace 110. In this way, the user increases the probability that the third-party user 114 will be attracted to the item and may wish to make a bid for the item on the marketplace 110. In yet another embodiment, the user of the mobile device 102 may desire to send the photograph and/or the weight of the item to friends using SMS and MMS messages. In this way, a group of friends and contacts can trade items with each other based on the pictures/videos of the items, the weight of the items, and the market price of the items to create an interactive private mobile marketplace. A skilled person in the art will recognize that the system 100 provides many opportunities to exchange items using internet websites, wireless communication, and messaging capability.

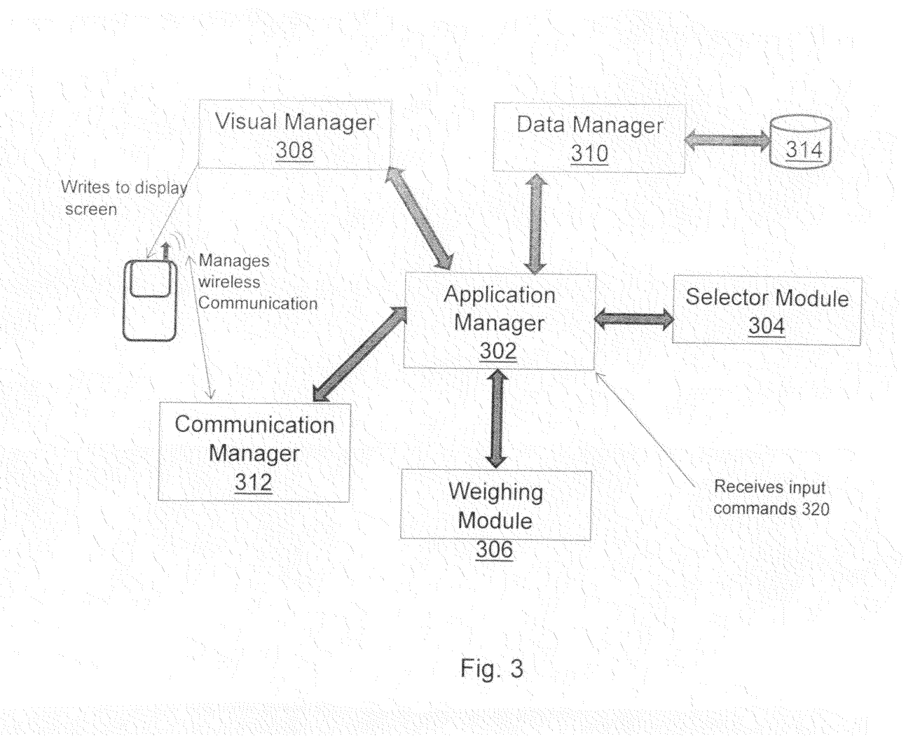

Referring next to FIG. 3, the mobile application of the system 100, includes modules 302, 312, 306, 304, 310, 308 and others that perform the necessary functionality to weigh the item and communicate the weight over a network 108. The modules may reside as software modules, hardware modules, firmware modules and/or in any combination. It will be appreciated that the modules 302, 312, 306, 304, 310, 308 may be an integrated execution code module or several software modules that interact with each other or in any form known in the art for executing an application on a mobile device.

The system 100 includes an application manager 302 that manages the interaction between the modules and the operating system of the mobile device 102. When the user of the mobile device 102 launches the weighing application, the application manager 302 is executed by the operating system and begins to interface with the user. The application manager 302 communicates with the visual manager 308 to display a user interface 205 to the user on the display screen 204. The visual manager 308 is operable to create digital images on the display screen 204 and to receive inputs from the user in the form of user events 320. The visual manager 308 instructs the selector module 304 to provide a selection of the type of items that the user may select to weigh on the mobile device 102. As mentioned above, the invention of the present application is operable to weigh any type of item that can physically fit on the weighing platform 212, 252 and is within the maximum and minimum weighing thresholds of the mobile device 102. For example, the selector module 304 may provide a data set of available items to the visual manager 308 to display on the display screen 204. The visual manager 308 may present the data set as a drop-down list on the user interface 205 or in any other format that may be convenient for the user such as but not limited to a numbered list or by category. It will be appreciated that the selector module 304 may update the data set from time to time by downloading updates over the network 108.

As the user views the selection list, the user may choose one of the available items or simply choose a category such as “other”, or watches, or jewelry, etc. (i.e.—items that are constructed out of more than one commodity). The user makes his/her selection and the visual manager 308 displays a user interface message to the user instructing the user to place the item on the weighing platform 212, 252. Once the user places the item on the weighing platform 212, 252, the weighing module 306 weighs the item by interfacing with weighing technology which may or may not be integral to the weighing platform 212, 252. The weighing module 306 determines if the item is within acceptable bounds of the hardware capability (i.e. above the minimum weighing threshold and above the maximum weighing threshold), and if the item weight is in an acceptable range, the weighing module 302 determines the exact weight and instructs the visual manager 308 to display the weight on the user interface 205.

The data manager 310 interfaces with the application manager 302 and other modules to manage and organize data and information that may be required by the mobile application. For example, the data manager 310 may read, write and delete records from a database 314 or from a set of data sets. It will be appreciated that a database 314 may take many forms such as a spreadsheet, a relational database, a text file, etc. that are commonly known in the art. The data manager 310 may also manage the persistence of data in memory such as RAM that are required by the mobile application. The data manager 310 may manage a variety of information such as but not limited to an internet cache of image and visual forms, internet cookies, a data set of the type of items supported by the mobile application and managed by the selector module 304, user IDs and passwords to be used by the both the mobile application and internet capable browsers, contact information for email, SMS and MMS communication and many other types of information as will be appreciated by one skilled in the art.

The communications manager 312 is for managing wireless communication of the mobile device 102 (i.e. transmitting and receiving data via the antenna 206). As shown FIGS. 1, 2a and 2b wireless communication may be accomplished by sending and receiving data in the form of encoded wireless signals 106. It will appreciated by one skilled in the art that wireless signals 106 are generally a form of electro-magnetic radiation of a particular frequency, however the invention also includes any known form of wireless signals 106. In one aspect, the communications manager 312 sends the weight and type of an item to a remote marketplace 110 such as an electronic commodities exchange. The marketplace 110 and communications manager 312 are adapted to coordinate the transfer of information between each other and potentially a third-party user 114. For example, when a user weighs an item on the mobile device 102, the user has an option to retrieve the real-time price of the item from the marketplace 110. If the user chooses to retrieve the real-time price, the communications manager 312 sends the weight of the item to the marketplace 110 via a communications relay 104 and a network 108 or another network configuration as is known. The marketplace 110 receives the incoming data sent by the communications manager 312, determines the real-time price of the item based on its weight, and sends the real-time price back to the mobile device 102 which is received and processed by the communications manager 312. It will be appreciated that the communications manager 312 may then relay the incoming real-time price to other modules, for example, but not limited to the application manager 302 and the visual manager 308 for further processing and display to the user.

In another embodiment, the communications manager 312 interfaces with other wireless parties such as contacts of the user of the mobile device 102. In this embodiment, the communication manager 312 processes emails, SMS or MMS messages and delivers the messages to the receiver based on the contact information stored on the mobile device 102. The communications manager 312 is adapted to attach digital files, such as, but not limited to digital videos and digital images which may represent the item to any message configured and delivered by the communications manager 312.

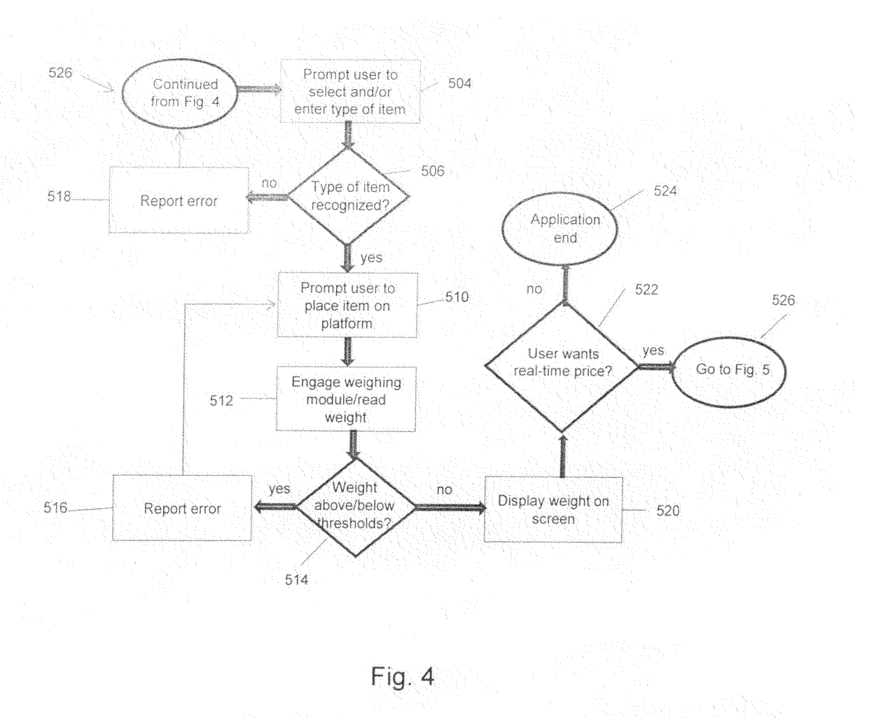

Reference is next made to FIG. 4 to describe the use of an embodiment of the present invention. To use the invention of the present application, a user launches the application at step 502 generally via a user interface 205 displayed on the display screen 204 of the mobile device 102. Once the application is launched successfully, the application prompts the user at step 504 to select the type of item that the user wishes to weigh. If the item is of a type that is not supported by the application at decision 506, an error message is reported to the user at step 518 and the application returns to its starting point at position 502. In another embodiment (not shown), the user is given an option to select any type of item, even an item that is categorized as “other” and the application goes directly to step 510 without performing decision 506.

At step 510 the user is prompted to place the item on the weighing platform 212, 252. The application may prompt the user at step 510 to instruct the application (for example by hitting the enter key) that the item has been placed on the weighing platform. In another embodiment, the application automatically senses the placement of the item on the weighing platform 212, 252 and proceeds to step 512 without any prompting by the user.

It will be appreciated by one skilled in the art that the balancing of the mobile device 102 may be an important consideration in ensuring that a proper weight of the item can be obtained. In the present application, balancing refers to the proper orientation of the device with respect to gravity, so for example, the mobile device 102 is most accurately used to weigh an item when the force of gravity is substantially perpendicular to the weighing platform 212, 252. Accordingly, in one embodiment of the invention a balancing module (not shown) is engaged at step 510 to ensure that the mobile device 102 is properly balanced. The balancing module may incorporate a variety of balancing sensors, such as, but not limited to gyroscopes and/or accelerometers. Such sensors determine whether the mobile device 102 is properly oriented with respect to gravity and will report via the balancing module to the user at step 510 to adjust the mobile device 102 until the device is balanced within the appropriate degree of error. If no such errors are reported to the user, the application continues to step 512.

At step 512, the application engages the weighing module 306 to determine the weight of the item. In one embodiment, the weighing platform 212, 252 of the mobile device 102 has physical thresholds outside of which the weighing platform 212, 252 is not capable of processing. For example, the weighing platform 212, 252 may not be able to weigh an item below a certain minimum threshold. Alternatively, the weighing platform 212, 252 may have a maximum threshold that should not be exceeded, since any item above the maximum threshold may cause physical damage to the weighing platform 212, 252. At decision 514, the method determines whether the item placed on the weighing platform 212, 252 is within the operable thresholds of the mobile device 102. If the item is not in the acceptable range, the application reports an error to the user at step 516 and returns to step 510. If the weight of the item is acceptable, the application proceeds to step 520.

At step 520 the application reports the weight of the item to the user. The weight may be reported in several ways including visually, orally, and in any other suitable fashion. At decision 522, the user is presented with the option to determine the real-time or market price of the item by accessing a marketplace 110. It will be appreciated that the price of only certain types of items can be accurately predicted for an item. For example, pure commodities such as gold, silver and diamonds can be accurately determined based on the weight of the item and the current market price per weight. Other items such as jewelry and non-reported commodities such as foodstuffs may not have a marketplace which is able to accurately predict the price because the price per weight is not reported by a commodities exchange or the item is made out of several different types of materials.

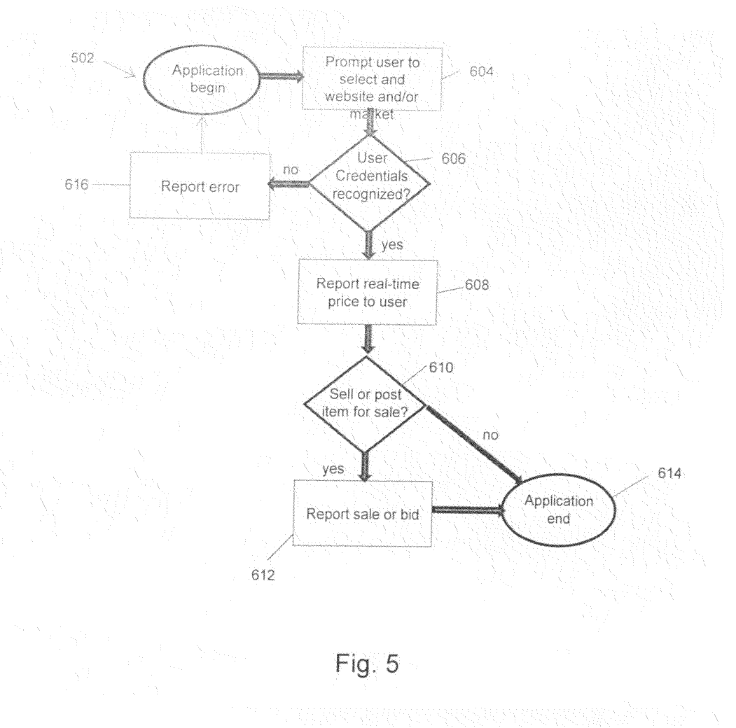

If the user does not desire to know the real-time price, the application ends and returns to step 502 to begin the process for another item. Otherwise, the application continues as shown in FIG. 5.

Referring next to FIG. 5, the method of the invention allows the user to determine the price of the item weighed and to sell or place the item up for sale at the marketplace 110. At step 604 the user is prompted to select an online market or website that the user desired to access. As mentioned above, the list of websites may be presented as a list of links. In one embodiment, the user has a preferred market 110 and the method automatically continues to step 606 without the user being prompted to make a selection. At decision 606, the method of the application determines if the user identification information is acceptable to the market 110. If the user identification is not recognized (or if the website cannot be accessed due to technical difficulties) an error is generated at step 616 and the application ends. If the user credentials are accepted by the market, the market retrieves the real-time price of the item which is reported at step 608. At decision 610, the user is given the option to sell or otherwise post the item on the marketplace 110. If the user does not wish to post the item, the application terminates at 614. It will be appreciated that not all marketplaces are able to provide this capability to the user. Finally, if the user chooses to post the item at decision 610, the method of the application reports to the user at step 612 that the item has been successfully posted and/or sold at which point the application ends at 614.

It will be appreciated by those skilled in the art that the invention can take many forms, and that such forms are within the scope of the invention as claimed. Therefore, the spirit and scope of the appended claims should not be limited to the descriptions of the preferred versions contained herein.

1. A mobile device having a system for weighing an item, wherein the mobile device has at least one computer processor and a display screen, the system comprising:
at least one weighing platform integral to the mobile device for receiving the item thereupon;
a selector module for allowing a user to select the identity of the item to be weighed;
a weighing module for determining the weight of the item placed on the weighing platform; and
a display module in communication with the weighing module for receiving the weight therefrom, and for displaying the weight on the display screen;
wherein the selector module, the weighing module, and the display module are executed by said at least one computer processor.

2. The system of claim 1, further comprising a communication module for communicating the weight and the identity of the item to a marketplace.

3. The system of claim 2, further comprising a value module for determining the value of the item according to data received from the marketplace, wherein the value module is executed by said at least one computer processor.

4. The system of claim 1, wherein the display screen is integral to the weighing platform.

5. A method for determining the weight of an item using a mobile device, the mobile device having at least one computer processor, a weighing platform and a display screen, the method allowing the user to carry out the steps of:
selecting the identity of the item to be weighed;
placing the item on the weighing platform;
determining the weight of the item by said at least one computer processor executing weighing module; and
displaying the weight of the item on the display screen.

6. The method of claim 5, further comprising the step of communicating the weight to a marketplace.

7. The method of claim 6, further comprising the step of retrieving the price of the item from the marketplace.

8. The method of claim 7, further comprising the step of allowing the user to sell the item at a pre-determined price on the marketplace.

9. A mobile device having a system for communicating the weight of an item to a marketplace, wherein the mobile device has a mobile device comprising at least one computer processor, a display screen, the system comprising:
a weighing platform adapted to weigh the item on the weighing platform,
a receiver and a transmitter;
a communications relay for receiving the weight sent by the transmitter of the mobile device, and for relaying the weight to at least one network,
the at least one network being adapted to send the weight to the marketplace.

10. The system of claim 9, further comprising a transaction processor coupled to the marketplace for allowing a user to sell the item on the marketplace to another party.
